(19) United States
(12) Patent Application Publication
(10) Pub. No.: US 2008/0006804 A1
(43) Pub. Date: Jan. 10, 2008

(54) Cable Drive

(76) Inventor: Gerhard Pfanzer, Bad Camberg (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 11/572,049

(22) PCT Filed: Jun. 16, 2005
(86) PCT No.: PCT/EP05/52791

§ 371 Date: Jan. 12, 2007

(30) Foreign Application Priority Data
Jul. 16, 2004 (DE) 10 2004 034 452.3

(51) Int. Cl. F16D 65/34

(52) U.S. Cl. 254/267

(57) ABSTRACT

A cable drive (1) has a drive motor (3) for tensioning a cable (7) by a transmission (5) connecting an output shaft (4) of the drive motor (3) to the cable (7) by a drive train (8). A stop brake, especially for a motor vehicle, may have a cable drive. In order to block the cable drive (1) in a simple manner, a brake train (14) is provided parallel to the drive train (8), connecting the motor output shaft (4) to the cable (7), wherein the brake train has a self-locking device. One such cable drive can be actively connected to a brake device for the actuation of the stop brake.

### CROSS-REFERENCE TO RELATED APPLICATIONS

This application is a U.S. national stage application of International Application No. PCT/EP2005/052791 filed Jun. 16, 2005, which designates the United States of America, and claims priority to German application number DE 10 2004 034 452.3 filed Jul. 16, 2004, the contents of which are hereby incorporated by reference in their entirety.

### TECHNICAL FIELD

The invention relates to a cable drive having a drive motor for tensioning a cable by means of a gearing that connects an output shaft of the drive motor to the cable via a power train. The invention further relates to a stop brake, in particular for a motor vehicle, having a cable drive.

### BACKGROUND

An above-cited cable drive is known for, for example, actuating a brake cable in a vehicle, with a feed shaft that acts on said brake cable being self-inhibiting. With the brake cable tensioned, a locking action results therefrom that is able to permanently sustain locking of the brake and will counteract releasing thereof. What is disadvantageous about said cable drive is that the cable traction device's drive motor must have a high driving torque.

Another known solution for a device for sustaining a braking force in the case of a brake operated by cable traction provides for employing a ratchet having teeth that lock counter to a direction of drive rotation. That in particular fails to allow defined releasing of the brake and precise setting of a predefined braking force.

A cable drive, called a cable puller, is furthermore known that has an internal, frictionally engaged or form-fitting brake-sustaining device having a gearing that has an additional motor drive. Owing to its two drive motors, said cable drive has a highly complex structure and is expensive.

An electric-motor-operated parking brake and a method for controlling it are also known for a motor vehicle in general. An electric motor having a current sensor serves therein as the drive for a brake cable by means of a gearing having a threaded rod, with the electric motor being stopped as soon as the current sensor signals a predefined value for the electric motor. The gearing is embodied as self-inhibiting. As in the case of the cable drive described further above, it is necessary here, too, for the electric motor serving as the drive motor to make a high driving torque available.

### SUMMARY

The object of the invention is thus to provide a cable drive of the type cited in the introduction that can have a drive motor exhibiting a comparatively low driving torque and which has a simple structure. The object of the invention is further to provide a stop brake of the type cited in the introduction which, with a simple structure, can be fitted with a drive motor exhibiting a comparatively low driving torque.

The first cited object can be achieved by providing a brake train that is parallel to the power train, connects the output shaft to the cable, and exhibits self-inhibiting.

According to an embodiment, in a cable drive a tensioning force is applied to the cable via the gearing's power train, whereas the cable tension is held by means of the self-inhibiting brake train. The brake train serves as a braking or locking element for the cable drive itself to maintain the cable tension at a specific level. The power train does not exhibit self-inhibiting. It can be structured in an easily moving manner, and only a small drive motor is necessary having a comparatively low driving torque. The consequence is a reduction in weight and less power draw for the cable drive, as a result of which it is suitable particularly for use in objects requiring to be moved, such as vehicles. According to an embodiment, the cable drive furthermore has a short response time; it can pull the cable very quickly and precisely. The drive motor's reduced power draw is advantageous for the motor's controlling and regulating means, which can be simplified and embodied economically. The noise produced by the cable drive according to an embodiment is low owing principally to there being no second or further drive motor. The cable drive is basically simple and economical to produce, assemble, and maintain owing to the comparatively small number of individual components. The high level of operating reliability and simple structure make the cable drive especially suitable for use as, for example, the drive of an electric-motor-driven stop brake as employed in, for instance, construction machinery or motor vehicles.

### BRIEF DESCRIPTION OF THE DRAWINGS

An exemplary embodiment of the invention is shown schematically in the drawing and described in more detail below.

FIG. 1 is a perspective view of a cable drive,

FIG. 2 is a side view of the cable drive shown in FIG. 1, and

FIGS. 3a to 3d each show a section through the cable drive shown in FIG. 1 in different operating states.

Elements that correspond have the same reference numerals in all the figures.

### DETAILED DESCRIPTION

According to an embodiment, the cable drive's structure will be further simplified if an adjusting spindle that acts on the cable is provided as the gearing's driven member.

It is conceivable that with, for example, couplings and/or free-wheeling mechanisms being used the power train and brake train have different transmission ratios. By contrast, the cable drive has particularly few components and will exhibit a high degree of operating reliability if, according to another embodiment, the power train and brake train act on the adjusting spindle with in each case the same rotational speed. The power train and brake train, which are each driven only by the drive motor, will hence have the same (overall) transmission ratio.

Self-inhibiting in the brake train can, according to another embodiment, be realized simply and economically through the brake train's having a worm gear.

According to another embodiment, the power train has a spur gear. That will make the power train economical to produce and it will be possible to transmit driving power via it with a high degree of efficiency. That will reduce the necessary driving power which the drive motor must make available for operating the cable drive.

It will be particularly advantageous if, according to another embodiment, a force sensor is provided for registering a tractive force of the cable. That will enable the drive motor to be switched off in response to, for example, a signal from the force sensor when a preset cable tension has been reached, and overtensioning of the cable thus to be avoided. The force acting on a device, for example a braking device, requiring to be actuated by means of the cable can also be detected with the force sensor and, where applicable, controlled together with the drive motor.

A hydraulically or pneumatically operated motor, for example, is basically also conceivable as the drive motor. It will, on the other hand, be particularly advantageous for controlling and regulating the drive motor in a simple manner as well as for structuring the cable drive economically if, according to another embodiment, the drive motor is an electric reversing motor. A reversing motor moreover offers the further advantage of being able to be used without any additional equipment, such as, for example, a reversing gear, not only for tensioning the cable but also for releasing and de-tensioning it in a selective, defined manner.

To insure secure locking of the cable based on self-inhibiting in the brake train when the drive motor is switched off, according to another embodiment, a drive train entry wheel driven by the output shaft and a brake train entry wheel driven by the output shaft are rotatable counter to each other around a common rotational axis.

According to another embodiment, the output shaft has a driver that can engage with a driver of the drive train entry wheel and with a driver of the brake train entry wheel and which drives the drive train entry wheel and/or brake train entry wheel. Selective, reliable force and torque transmission will be insured thereby with a simple structural design.

For unimpeded, fast establishing and acting of self-inhibiting in the brake train it will be particularly advantageous if, according to another embodiment, the drive train entry wheel is pretensioned counter to its direction of drive rotation when the cable is being tensioned against the output shaft.

The object cited second above can be achieved by providing a cable drive according to one of the embodiments in the case of a stop brake cited in the introduction, with said cable drive being functionally linked to a brake device for actuating it.

According to an embodiment, the cable that can be tensioned by the drive motor is a brake cable of the stop brake's actual brake device. Not to be confused with said brake device is the brake train in the cable drive, which brake train maintains the tension in the brake cable. Owing to its precise controllability, reliable functioning, and simple, maintenance-free structure, the stop brake is especially suitable for use as a motor vehicle's stop brake. The stop brake offers the added advantage that (mechanical) adjusting thereof is rendered superfluous through simple measures, for example using a force sensor for measuring the brake cable's tractive force and controlling the drive motor as a function of the measured traction force values; it will thus always be able to develop its optimal braking effect within very wide limits without the braking effect's being diminished by an elongating of the brake cable, for instance.

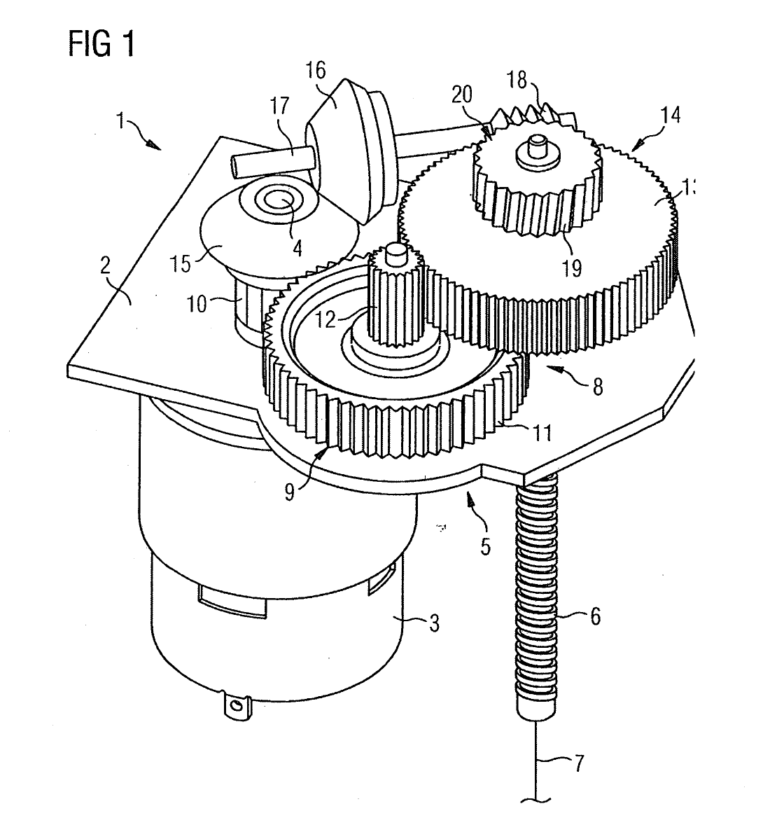

FIG. 1 is a perspective view of a cable drive 1 having a baseplate 2 on which, as the drive motor 3 of the cable drive 1, is mounted an electric motor having an output shaft 4 extending through the baseplate 2. A gearing 5 connects the output shaft 4 to a cable 7 connected to a non-self-inhibiting adjusting spindle 6. The cable 7 can be, for example, a brake cable of a motor vehicle's stop brake (not further shown here).

The cable 7 can be tensioned or tightened via a power train 8 of the gearing 5 by means of the drive motor 3. The power train 8 has a spur gearing 9 having a first spur gear wheel seated as the drive train entry wheel 10 on the output shaft 4, further spur gear wheels 11, 12, and a last spur gear wheel located as the drive train exit wheel 13 on the adjusting spindle 6.

A brake train 14 exhibiting self-inhibiting runs parallel to the power train 8 that connects the output shaft 4 to the cable 7. The brake train 14 has as the brake train entry wheel 15 a bevel gear seated on the output shaft 4, a bevel gear 16 that engages with said brake train entry wheel 15 and is located on a worm shaft 17 having a worm 18, and, as the brake train exit wheel 19, a worm wheel located on the adjusting spindle 6. The two bevel gears at the entry of the brake train could also be replaced by an arrangement having spiral-toothed gear wheels.

Self-inhibiting of the brake train 14 is effected by means of a worm gear 20 having the worm wheel and worm 18. The transmission of the power train 8 corresponds to that of the brake train 14 so that the power train 8 and brake train 14 act on the adjusting spindle 6 with the same rotational speed.

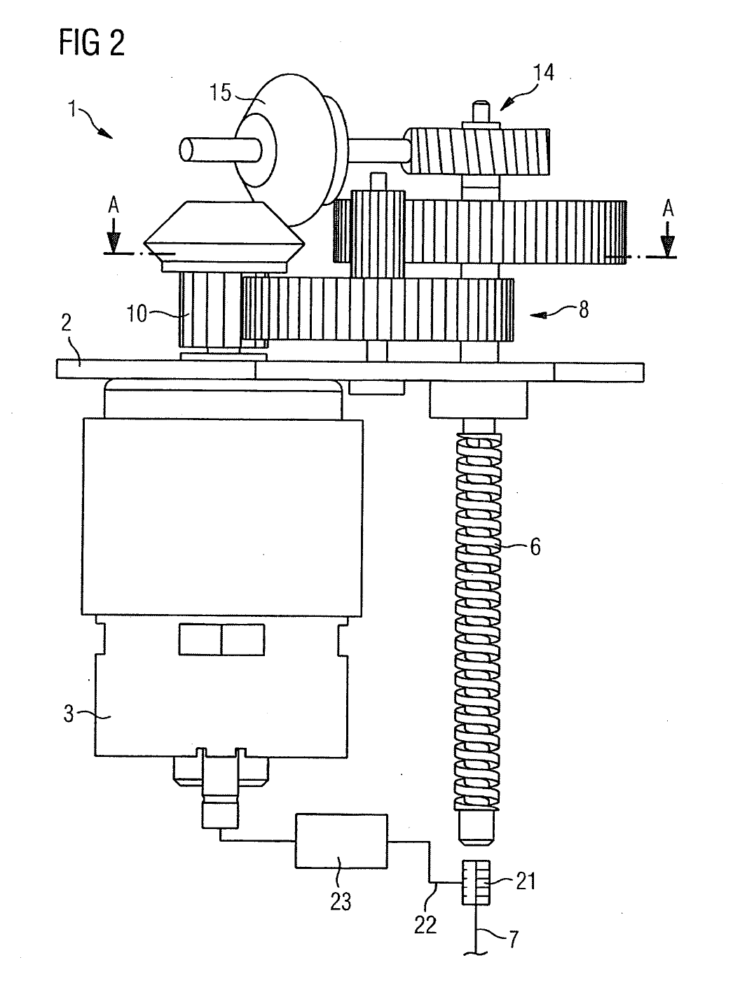

Alongside the general structure of the cable drive 1 having the drive motor 3, baseplate 2, power train 8, parallel brake train 14, and adjusting spindle 6, the side view of the cable drive 1 illustrated in FIG. 2 shows drawn on the cable 7 a schematic of a force sensor 21 for registering a tractive force of said cable 7. The force sensor 21 is provided via an electric lead 22 with motor control electronics 23 for controlling the drive motor 3, in particular for switching it off when a predefined force level of the tractive force of the cable 7 has been reached.

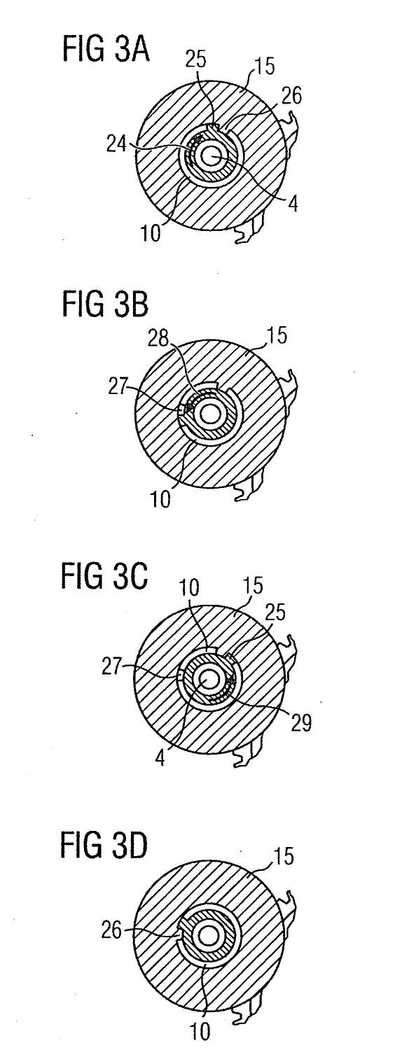

The interaction of the drive motor 3, which is a reversing motor, and the power train 8 and brake train 14 will be explained in more detail below with the aid of FIGS. 3a to 3d, each of which shows a section of a cross-section A-A from FIG. 2 in different operating states of the cable drive 1.

FIG. 3a shows the operating state “pull”, which lasts until the final position of the cable requiring being tensioned has been reached.

The output shaft 4, which is moved in the direction of an arrow 24, has a driver 25 connected to it in a torsion-resistant manner. Said driver 25 is located against a driver 26 of the brake train entry wheel 15 embodied as a bevel gear (see also FIG. 2) and against a driver of the drive train entry wheel 10 embodied as a spur gear wheel (see also FIG. 2). In the view according to FIG. 3a the driver of the drive train entry wheel 10 is obscured by the driver 26 of the brake train entry wheel 15.

When the drive motor is actuated in the pull direction the power train and brake train will thus run in the same direction until the drive motor is switched off, for example in response to a signal from the force sensor. When the drive motor has been switched off, the force present on the cable, for example from the stop brake, will attempt to turn the non-self-inhibiting adjusting spindle back.

Because the drive train entry wheel 10 and brake train entry wheel 15 are separated from each other and can rotate radially freely counter to each other (in this exemplary embodiment through approximately 300°), via the driver 27 of the drive train entry wheel 10, the power train can—as shown in FIG. 3b illustrating the operating state “de-tension”—turn back, overcoming the sum of the overall tooth play, in the direction of an arrow 28 (for example through 10° to 15°) only until the brake train exit wheel embodied as a worm wheel comes to rest in a self-inhibiting manner against the worm, with the brake train entry wheel 15 remaining static. The drive train entry wheel 10 and brake train entry wheel 15 can thus be rotated counter to each other around a common rotational axis—formed here by the output shaft 4.

A twist spring clip, not visible here, therein acts on the drive train entry wheel 10 to keep the brake train entry wheel 15 unimpeded and free for establishing self-inhibiting. The drive train entry wheel 10 will thus be pretensioned counter to its direction of drive rotation when the cable is being tensioned against the output shaft 4.

If the drive motor, as a reversing motor, is then supplied with current in such a way that the output shaft 4 moves in a release direction, symbolized by an arrow 29 in FIG. 3c showing the further operating state “release”, counter to the pull direction, the driver 25 seated on the output shaft 4 will first drive the brake train entry wheel 15 and thereby cancel the worm's self-inhibiting by means of the operating cable exit wheel (worm wheel), specifically until the above-cited driver 25 also impacts with the drive train entry wheel 10 with its driver 27.

Both the power train and brake train will then run in the release direction until the drive motor is switched off in a final position. This operating state “release all” is shown in FIG. 3d, wherein the driver 26 of the brake train entry wheel 15 again obscures the driver of the drive train entry wheel 10.

So that the cable 7 can be released in its pulled state in the event of a power failure causing the drive motor 3 to cease functioning, it is advantageously possible for the drive to be turned back manually, and the cable 7 hence de-tensioned, by means of a (hand-operated) tool that can be applied to the worm shaft 17.

What is claimed is:

1. A cable drive having a drive motor for tensioning a cable by means of a gearing connecting an output shaft of the drive motor to the cable via a power train, wherein a brake train that is parallel to the power train and connects the output shaft the cable is provided that exhibits self-inhibiting.

2. The cable drive according to claim 1, wherein an adjusting spindle that acts on the cable is provided as the driven member of the gearing.

3. The cable drive according to claim 1, wherein the power train and brake train act on the adjusting spindle with in each case the same rotational speed.

4. The cable drive according to claim 1, wherein the brake train has a worm gear.

5. The cable drive according to claim 1, wherein the power train has a spur gearing.

6. The cable drive according to claim 1, wherein a force sensor for registering a tractive force of the cable is provided.

7. The cable drive according to claim 1, wherein the drive motor is an electric reversing motor.

8. The cable drive according to claim 1, wherein a drive train entry wheel driven by the output shaft and a brake train entry wheel driven by the output shaft are rotatable counter to each other around a common rotational axis.

9. The cable drive according to claim 1, wherein the output shaft has a driver that can engage with a driver of the drive train entry wheel and with a driver of the brake train entry wheel and which drives the drive train entry wheel and/or brake train entry wheel.

10. The cable drive according to claim 1, wherein the drive train entry wheel is pretensioned counter to its direction of drive rotation when the cable is being tensioned against the output shaft.

11. A stop brake comprising a cable drive having a drive motor for tensioning a cable by means of a gearing connecting an output shaft of the drive motor to the cable via a power train and a self-inhibiting brake train that is parallel to the power train and connects the output shaft to the cable, wherein said cable drive being functionally linked to a brake device for actuating it.

12. The stop brake according to claim 11, wherein an adjusting spindle that acts on the cable is provided as the driven member of the gearing.

13. The stop brake according to claim 11, wherein the power train and brake train act on the adjusting spindle with in each case the same rotational speed.

14. The stop brake according to claim 11, wherein the brake train has a worm gear.

15. The stop brake according to claim 11, wherein the power train has a spur gearing.

16. The stop brake according to claim 11, wherein a force sensor for registering a tractive force of the cable is provided.

17. The stop brake according to claim 11, wherein the drive motor is an electric reversing motor.

18. The stop brake according to claim 11, wherein a drive train entry wheel driven by the output shaft and a brake train entry wheel driven by the output shaft are rotatable counter to each other around a common rotational axis.

19. The stop brake according to claim 11, wherein the output shaft has a driver that can engage with a driver of the drive train entry wheel and with a driver of the brake train entry wheel and which drives the drive train entry wheel and/or brake train entry wheel.

20. The stop brake according to claim 11, wherein the drive train entry wheel is pretensioned counter to its direction of drive rotation when the cable is being tensioned against the output shaft.
